(19) United States
(12) Patent Application Publication
(10) Pub. No.: US 2013/0013666 A1
(43) Pub. Date: Jan. 10, 2013

(54) MONITORING DATA ACCESS REQUESTS TO OPTIMIZE DATA TRANSFER

(75) Inventors: Muli Ben-Yehuda, Haifa (IL); Daniel Citron, Haifa (IL); Itzhack Goldberg, Hadera (IL); Nadav Har'El, Manof (IL); Dorit Nuzman, Haifa (IL); Ayal Zaks, Mitzpe aviv (IL)

(73) Assignee: International Business Machines Corporation, Armonk, NY (US)

(21) Appl. No.: 13/177,566

(22) Filed: Jul. 7, 2011

(51) Int. Cl. G06F 15/16

(52) U.S. Cl. 709/203

(57) ABSTRACT

A data transmission optimization method and system. The method comprises analyzing program code to identify data access calls in the program code, using one or more processor; determining whether a first data access call is for retrieving target data stored in a data structure with a plurality of fields, wherein the target data is stored in one or more target fields of the data structure; determining whether servicing the first data access call will result in transfer of non-target data stored in one or more non-target fields in the data structure; and replacing the first data access call with a second data access call, wherein servicing the second data access call will result in transfer of the target data and minimizes the transfer of non-target data.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to data transfer in a computing environment and, more particularly, to monitoring data access calls in a program code to optimize the corresponding data transfer.

### BACKGROUND

In a computing environment, programs or applications may need to read data from storage resources that in some instances reside on remote networks. Read requests that are directed to scattered data elements (i.e., data stored on nonconsecutive data blocks) often result in transfer of data that includes more than the target data elements.

For example, consider the following pseudo code directed to a process for reading an entire data structure S with multiple data elements, where the target data that is needed is stored in a single field (i.e., “intField”) in the data structure:

```
/* C language example of reading large structure and using only a single
field */
#define N 1000
typedef struct S { /* size of S is 1001*sizeof(int) = 1001*4= 4004 */
    int array[N];
    int intField;
}
/* function foo receives a file descriptor and returns the value in intField */
int foo(int file){
```

| | |
|---|---|
| S buf; | /* define structure of type S called buf */ |

big_read(file, &buf, sizeof(S)); /* read from a file (on disk) 4004
bytes into memory (variable buf) */

| | |
|---|---|
| return buf.intField; | /* read from memory into register */ |
| } | |

In this example, the data structure S has N+1 data elements, where N elements are in the first field which includes an array of 1 through N elements, and the second filed includes a single integer element “intField”. The “big_read” can be a read( ) or fread( ) function call, for example. Generally, the execution of program code such as snippet 1 above results in fetching the entire data structure S from a data storage medium, even if the read request is only for the purpose of reading the value of a single element (e.g., intField). The entire fetched data is then transferred to local memory, and the value stored in “intField” is extracted from the data stored in local memory.

If the data storage medium is located remotely, the transfer of the entire data structure is particularly wasteful of the network bandwidth, because N extra data elements in the array (i.e., the first field) are transferred as a part of the read request that was initiated to read a single data element in the “intField” (i.e., the second field) of the data structure S. The above practice is fundamentally a result of standard software engineering practices that advocate reading entire records and later extracting the needed data from the target fields. Modular code development in particular promotes the use of reusable components and general interfaces at the programmer level, relying on later stripping/specialization/optimization by the compiler).

The principle of data locality also dictates that the underlying infrastructure (e.g., operating system, network protocol, etc.) that implements or carries out remote data accesses is designed to support access to consecutive data blocks. As a result, when reading scattered data elements, fixed block sizes are accessed and existing operating systems fetch whole data blocks into a buffer, and then return the target data from the data stored in the buffer. Of course, the idea is to provide additional efficiency if the same buffer includes data that are the target of a subsequent read request.

One can appreciate that if target data for subsequent read requests is not in the buffer, then the above scheme is highly inefficient because, typically, the entire content of the buffer will be flushed and additional blocks of data are transferred in. Thus, in cases where data locality is poor, the above scheme results in unnecessary data transfers which waste data communication bandwidth. This wasteful practice is especially problematic in computing and storage environments that rely heavily on remotely situated resources for processing and storing data (e.g., cloud computing involving the use of virtual machines and other virtual resources).

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a data transmission optimization method and system is provided. The method comprises analyzing program code to identify data access calls in the program code, using one or more processor; determining whether a first data access call is for retrieving target data stored in a data structure with a plurality of fields, wherein the target data is stored in one or more target fields of the data structure; determining whether servicing the first data access call will result in transfer of non-target data stored in one or more non-target fields in the data structure; and replacing the first data access call with a second data access call, wherein servicing the second data access call will result in transfer of the target data and minimizes the transfer of non-target data.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIGS. 1A, 1B and 1C illustrate an exemplary computing environment in accordance with one or more embodiments, wherein data read from a disk media is stored in memory; then the data cached and later loaded into a register.

FIGS. 2A and 2B are exemplary block diagrams of a computing environment in which optimized data read from disk media is stored in memory; then the data is cached and loaded into a register, in accordance with another embodiment.

FIG. 3 is a flow diagram of an exemplary method for optimizing data access calls in a program code, in accordance with one embodiment.

FIGS. 4A and 4B are block diagrams of hardware and software environments in which the disclosed systems and methods may operate, in accordance with one or more embodiments.

FIG. 5A depicts a cloud computing node according to one embodiment.

FIG. 5B depicts a cloud computing environment according to one embodiment.

FIG. 5C depicts abstraction model layers according to one embodiment.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

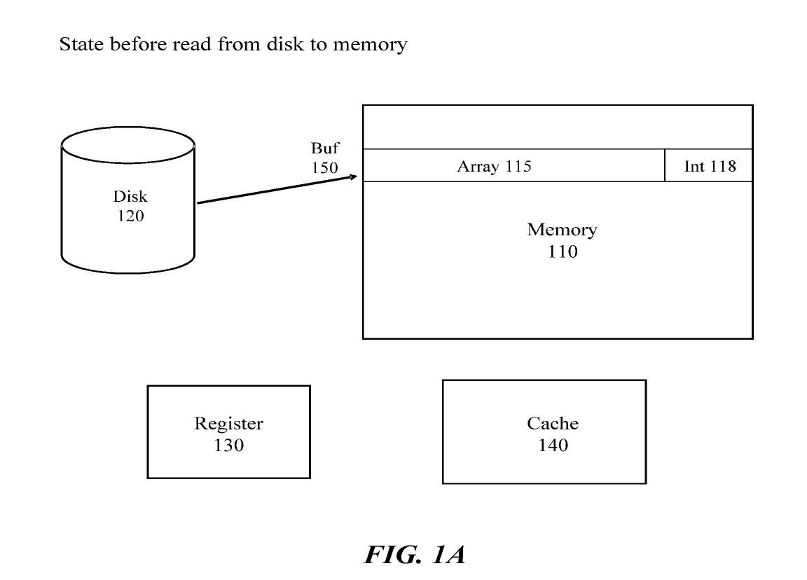

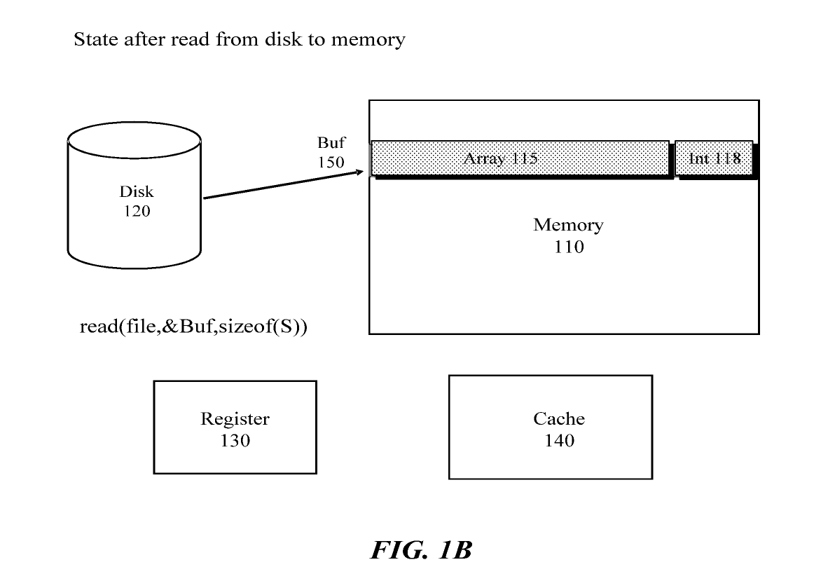

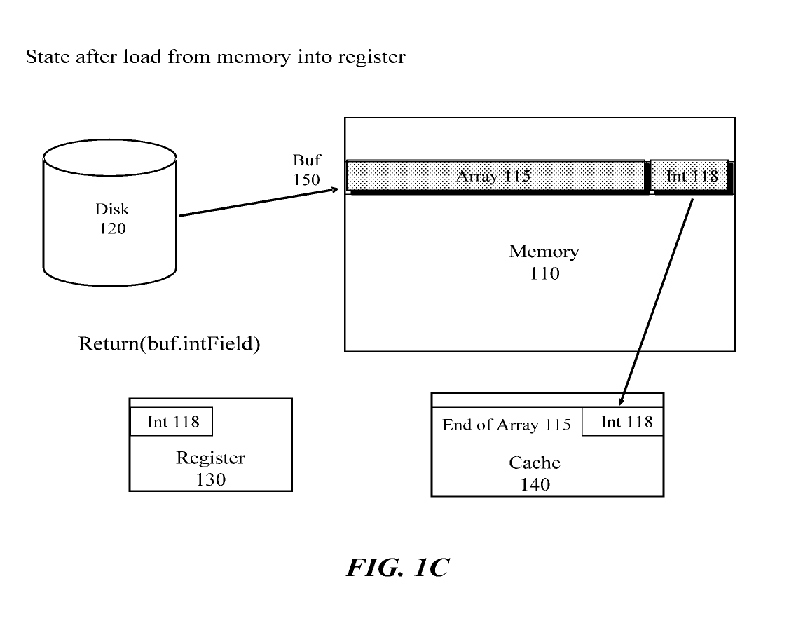

Referring to FIGS. 1A, 1B and 1C, an exemplary computing environment is illustrated in which a data storage medium (e.g., disk 120) is remotely accessed to retrieve data stored thereon. A memory 110, register 130, and cache 140 are also shown. Depending on implementation, memory 110, register 130 and cache 140 may be included in a client computing system configure to access a server computing system residing in a remote network, for example. The server system provides access to data stored on one or more data storage media including disk 120, for example, and serves data requests submitted by the client.

FIG. 1A illustrate an example data transfer state in one embodiment where the client has submitted a read request for data stored on disk 120. In this example, the request is for accessing data stored in a data structure composed of multiple fields. The first field in the data structure is array 115 having N elements, and the second field includes an integer int 118. In this embodiment, in order to read the value in the second field, the entire data structure is read from disk 120 and is placed in memory 110 (see FIG. 1B).

Provided below is an exemplary code written in C language for reading the value int 118 in a target field in data structure S, when an exemplary function “foo” is called. Referring to FIGS. 1B and 1C, in response to the function call, data bytes in the defined data structure S are read from disk 120 and loaded into memory 110—the loaded data includes N elements of array 115 and the value of the field that includes int 118 (see FIG. 1B). The data bytes associated with int 118 and end of array 115 are stored in cache 140 and ultimately int 118 value is read from cache 140 and is written to register 130 (see FIG. 1C). Depending on implementation, in one embodiment, int 118 value may be directly copied from memory 110 to register 130 without caching.

```
#define N 1000
typedef struct S { /* size of S is 1001*sizeof(int) = 1001*4= 4004
*/
    int array[N];
    int intField;
}
/* function foo returns the value in intField */
int foo(int file){
```

| | |
|---|---|
| S buf; | /* define structure of type S called |
| buf */ | |

read(file, &buf, sizeof(S)); /* read from a file (on disk) 4004
bytes into memory (variable buf) */

| | |
|---|---|
| return buf.intField; | /* read from memory into register */ |
| } | |

In the above example, if N is equal to 1000, then servicing the function call foo will result in the transfer of 4004 bytes from disk 120 to memory 110, where each data element is 4 bytes in size (i.e., 4×1000 array elements in the first field+4×1 integer element in the second field). Note that this relatively large data transfer has taken place in response to a function call that is only interested in retrieving the value of int 118 which is 4 bytes in size. Thus, in this example, the other 4000 bytes of data are wastefully transferred, especially if the subsequent function calls do not need to access the values for any of the array 115 elements.

As provided in further detail below, to help address the above inefficiency, one or more embodiments are implemented to focus on transferring the target data bytes. During compilation of a program code, data access requests (e.g., read requests) are analyzed to determine if a smaller portion of a data structure may be read instead of the entire data structure. This approach is useful in reading from remotely located data resources (e.g., in a cloud computing environment) where remote data transfer takes time and network bandwidth. Reading a part of a data structure instead of the entire data structure helps speed up data access and preserves network bandwidth.

In one embodiment, the respective program code is instrumented and a profile of the code execution is collected. The compiler uses the profile information to look at a function or operation that requires the reading of a data structure and determines if the reading of the entire data structure is necessary or whether reading a small number of fields (i.e., data bytes) in the data structure would be sufficient. Other than looking at the function or operation parameters, depending on implementation, the compiler may perform a forward data flow analysis (e.g., look ahead in the code) to determine the need for reading the entire data structure or only a portion (or smaller portions) of it.

As provided in further detail below, in addition to the forward data flow analysis process, which is performed at compilation time, other tools such as data profiling and memory tracing may be used to determine how certain values or fields in a record are used or accessed during execution in order to help optimize the program code. These additional tools may require the code to be executed during one or more test runs so that the corresponding profiling data or memory traces are obtained and utilized when the code is recompiled.

By way of a general example, consider a data structure X that includes an array in field 1, and values A, B, C and D in fields 2, 3, 4 and 5 respectively. The array in field 1 may be very large (e.g., an array of 10,000 elements). A function or operation call to read the entire data structure X would be wasteful if only values in fields 2 and 3 (i.e., target fields) are needed for the purpose of the submitted read request. Thus, in one embodiment, the compiler instead of reading the entire data structure will transform the code to read only A and B from fields 2 and 3 in preferably a single read, or if needed in more than one read.

Depending on the particular scenario and factors provided below, the compiler evaluates whether or not the code transformation would optimize the code's execution. If so the compiler transforms the code. The transformation, depending on implementation, takes into consideration the factors below:
1. The spatial locality of the target fields—if data to be read for two or more target fields is spatially close such that the related data may be retrieved in one read, for example, then there is more incentive for the compiler to transform the code, in comparison with a scenario where several reads need to be performed to retrieve the values for the target fields.
2. The need for values in the data structure other than the values in the target field—if the compiler looks ahead in the code and determines that at a later point in execution the program will need to use values other than those in the target fields, then there may be a higher incentive to read the entire data structure the first time, instead of reading a targeted field first and having to read the rest of the fields in the data structure later.
3. The size of the cache line in relationship to the size of the entire data structure—depending on the number of the target fields, the spatial locality of the fields and the size of a cache line, the compiler may determine how many reads will need to be performed to retrieve the values for the target fields. If transforming the code to retrieve individual field values creates an additional burden on the code, then the compiler may read the entire data structure, instead of the individual fields.

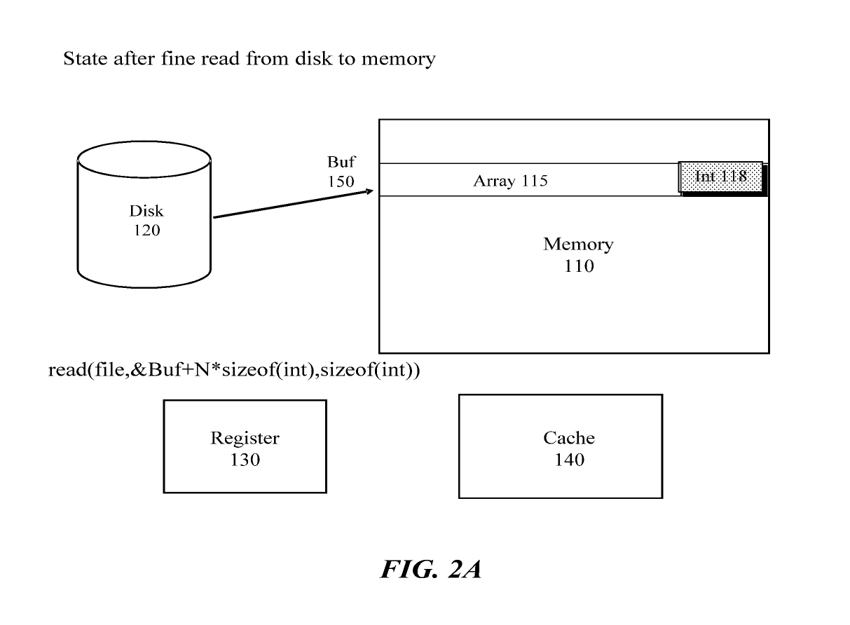

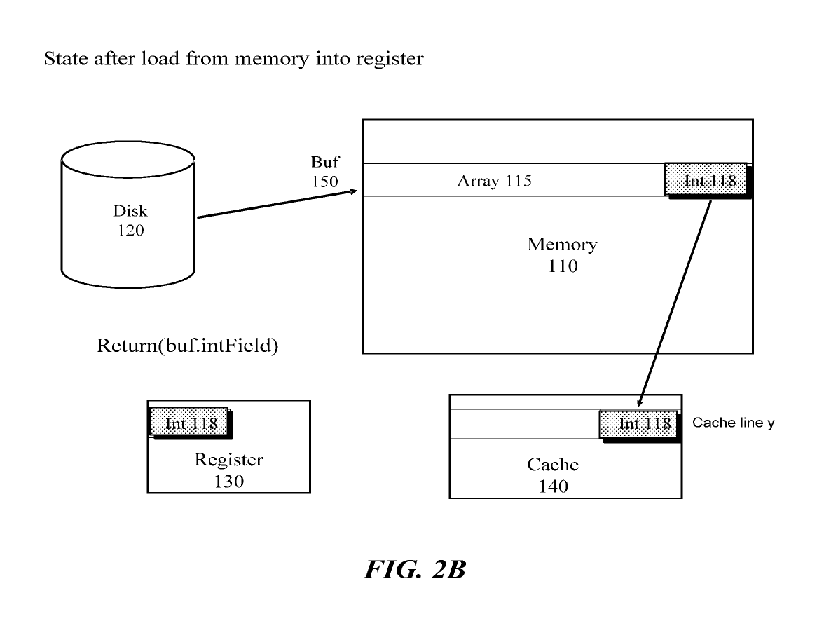

Provided below is an exemplary code written in C language for reading the value int 118 in a target field in data structure S, when an exemplary function “foo” is called. Referring to FIGS. 2A and 2B, in response to the function call, the data bytes in the target field (i.e., “intField”) in the data structure S are read from disk 120 and loaded into memory 110—the loaded data does not include the N elements of array 115 but includes the value of the int 118 (see FIG. 2A). Then, the data bytes associated with int 118 are stored in cache 140 and ultimately int 118 value is read from cache 140 and written to register 130 (see FIG. 2B). Depending on implementation, in one embodiment, int 118 value may be directly copied from memory 110 to register 130 without caching.

```
#define N 1000
typedef struct S { /* size of S is 1001*sizeof(int) = 1001*4= 4004
*/
    int array[N];
    int intField;
}
/* function foo receives a file descriptor and returns the value in intField
*/
int foo(int file){
```

| | |
|---|---|
| S buf; | /* define structure of type S called |
| buf */ | |

```
    lseek(file,N*sizeof(int),SEE_CUR); /* move the file position */
    read(file, &buf+N*sizeof(int), sizeof(int)); /* read from a file
(on disk) 4 bytes into the intField of the structure */
```

| | |
|---|---|
| return buf.intField; | /* read from memory into register */ |

In the above, by way of non-limiting example, sample codes were provided to explain one or more example embodiments in a general discussion. In the following, more specific examples are provided that explore other alternative embodiments in some detail. Certain features discussed in the following embodiments may be the same, similar or have overlapping elements to what has been discussed above. Never-the-less, it should be noted that all the embodiments disclosed herein are by way of example and should not be construed as limiting the scope of the claimed subject matter to specific details.

In accordance with one embodiment, an optimized code for reading a target field (e.g., intField) in data structure S may be written as follows:

int foo(int file){

| | |
|---|---|
| S buf; | /* define structure of type S called buf */ |

```
    lseek(file,N*sizeof(int),SEE_CUR); /* move the file position */
    fine_read(file, &buf+N*sizeof(int), sizeof(int)); /* read from a
file (on disk) 4 bytes into the intField of the structure */
```

| | |
|---|---|
| return buf.intField; | /* read from memory into register */ |

The “fine_read” idiom may take the form of a pread( ) function call which can take a specific offset, or operating system hints such as posix_fadvise( ) or O_DIRECT. Bandwidth, readability and portability implications (e.g., involving offset calculations) are also taken into consideration when deciding on how the code is to be optimized. Further, to minimize network bandwidth consumption when reading data, the spatial and temporal locality of resources involved in the read operation may be also taken into account. For example, multiple read requests in multiple locations may be buffered and merged through a software stack. In situations that exhibit poor spatial locality, prefetching or buffering are not helpful and may not be utilized.

Depending on implementation, different idioms may be used to express the “fine_read”. For example, the idiom fadvise( ) or posix_fadvise( ) that directly apply to a file descriptor may be used to hint whether reading from the file descriptor will be done in random order or whether the cached data may be reused. In one embodiment, the optimization scheme may rely on compiler analysis to first detect read requests that result in transfer of more than the target data to a requesting application and convert such read to more refined read (e.g., “fine_read”) requests.

In one example embodiment, compiler analysis may detect that a certain target field (e.g., the “intField”) is the field from which a needed value is to be read out of the entire data structure. The compiler may thus generating a “fine_read” call (e.g., using “pread” or a read preceded by a lseek) as provided in the exemplary snippet 2 above. By retrieving the target information, redundant read-ahead, caching or buffering optimizations by the underlying software stack may be avoided, resulting in data transmission efficiencies between server and client systems.

Using the above-noted methods, advantageously, the compiler and the operating system may seamlessly handle an efficient application programming interfaces (API's) between a client submitting read requests, and a server that manages the responses to the submitted read requests. This scheme not only reduces the transmission bandwidth over the respective networks but also allows the programmers to write the corresponding codes without having to determine offset calculations for reading the target data from a target field. Further, the addition or omission of a field from a data structure will not require a complete code revision.

Several methods may be used to increase spatial locality, both by applying code transformations (e.g., loop interchange) and data layout transformations (e.g., single-field-of-a-struct cases such as that illustrated in snippet2). Such methods may require program analysis and perfect aliasing knowledge, and are orthogonal and complementary to the methods discussed earlier which provide efficient support in scenarios where existing buffering and caching mechanisms are useless or harmful.

The methods discussed above may apply to general-purpose applications, especially those that have poor spatial locality. For example, the methods may apply to situations that involve calls to fread( ) as well as calls to read( ). The former performs additional buffering, and may also benefit from a similar conversion to pread( ) when a small amount of the data being (f) read is actually needed, as this conversion will eliminate such extraneous buffering.

The discussed methods are also applicable to systems services such as readdir( ) and stat( ). These system services populate relatively large structures while applications might actually need a handful of variables within the respective structures, or perhaps the return-code. Using the above schemes, such services may be tailored to transfer relevant data, thereby to better serve in a cloud-environment. For example, where the cache line is 128 bytes, the processor may read a whole cache line even if the item to be read is less than 128 bytes.

Depending on implementation, if the item to be read is larger than 128 bytes, then the discussed methods may applicable to both kernel and user-level code. Further, the discussed methods are applicable to both local and remote scenarios. In some embodiments, the user code is transparently and automatically changed such that the crude read of a whole block of data is converted to a finer-read of the target fields used by the program.

In the context of local reads, the benefit of the above methods is limited to cases where the read requests are bigger than the size of the block that can be physically read from the disk. The size of such blocks may be 512, 1024 or 4096 bytes, and thus reads of data structures that are substantially larger than such block sizes may benefit from the above noted methods. On the other hand, in a remote access scenario, reducing to fine_reads that are even smaller than disk block size is beneficial.

For example, with a network filesystem, if one can transfer just 4 bytes instead of 512 bytes on the wire, there is already a benefit of reducing data transfer over a potentially slow and expensive WAN. Even if the actual physical read results in reading a block size of 512 bytes or more, the above method allows the driver and other software layers around it, to drop the irrelevant data before submitting it for transmission over the network. Moreover, the above methods may prevent the software layers from adding more irrelevant data, by avoiding extra fetching of data, as is common place in certain legacy file systems such as NFS.

The discussed methods may be implemented by a compiler transformation within existing source-to-source, static, post-link or dynamic compilers, or as a stand-alone tool. Consider the following exemplary code:

```
snippet 3:
#define N 1000
#define M 10000
struct S {
        int array[N];
        int intField;
    } *buff;
    int store[M];
    int current_position = 0;
    static void store_int(struct S* in){
        store[current_position++] = in->intField;
    }
    int foo( ){
        int ok = big_read (file_location,buff,sizeof(struct),);
        if (ok)
          store_int(buff);
        return buff->intField;
    }
```

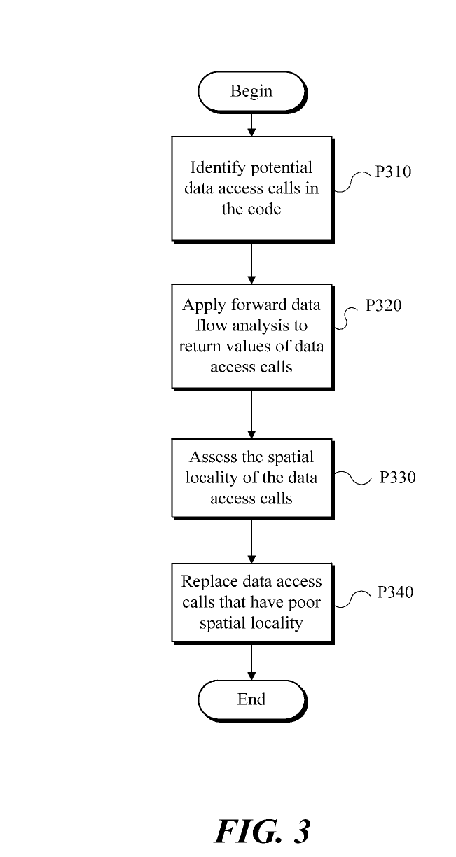

Referring to FIG. 3, the transformation in the above code is initiated by desirably automatically identifying potential data access calls (i.e., read or write calls) in the code (P310), such as calls to (f) read or (f) write. The read may be augmented with programmer indication of which accesses to focus on. Feedback information in the form of profiling or memory access traces may be also used. Considering the example in snippet 3 above, in one embodiment, the function foo is analyzed and the “big_read” call is identified as a potential read access to be optimized.

In accordance with one or more embodiments, forward data-flow analysis may be applied to the return values of the data access calls (e.g., read( ) calls) (P320), potentially tracking the values through struct objects, procedure calls, and temporary object constructions. In one example, the forward data-flow analysis may provide the locations that make actual use of the data that was accessed, and determine the exact field(s) that are extracted and used, in response to the data access call.

In some cases, the analysis may fail to identify the possible use locations. If the data accesses are not in the scope being analyzed, the analysis may mark every potential escape point. This analysis may be context-sensitive, where a common utility procedure is called by different procedures to perform the desired read access, each one interested in its own specific subset of fields. Context-sensitive analysis may be used to optimize each such use separately, by applying code duplication, cloning, specialization or inlining.

Considering the example in snippet 3 above, the uses of “buff” may be analyzed, starting from the “big_read” call site. Using forward inter-procedural data flow analysis, the uses of “buff” or any escape points may be analyzed. In the above example, the analysis would result in finding the “buff->inField” and “in->inField” as the usages of “buff”, and no escape locations are identified.

In one embodiment, the spatial locality of the data access calls is assessed (P330). The goal of this step is to estimate, for each access that was analyzed, how much of the data that was accessed was in fact useful. Depending on implementation, heuristics may be applied, e.g. considering characteristics of cache line sizes and the distance (in terms of data accesses) between different uses. The feedback information in the form of profiling and memory-access traces may help in estimating the amount of data actually being used on average.

Considering the example in snippet 3 above, a single access is found (both “buff->inField” and “in->inField” access the same location). Thus, there is no spatial locality, and the respective read( ) call would be considered candidate for transformation. Consider also the example code below:

```
snippet 4:
        struct S {
            int array[N];
            int intField;
        } buff[M];
    int foo( ){
            int sum = 0, i;
            for (i=0; i<M; i++){
                big_read (buff[i], 1, sizeof(struct), file_location);
                sum += buff[i]->intField;
            }
            return sum;
    }
```

In the above example, it is determined whether “buff[i]->intField” accesses across consecutive iterations of the i-loop are “far” enough from one another to justify the transformation of a “big_read” into a “fine_read”. When optimizing for local disk accesses, the distance between the different accesses (e.g., (N+1)*4 bytes) is considered relative to disk block size (minimal physical size that can be read from the disk) as well as the cache line size. In case N is small, consecutive “buff[i]->intField” accesses may reside not only in the same disk block, but also within the same cache line size, in which case reading the data using the “big_read” call would benefit from spatial locality and the “big_read” call would not be considered candidate for transformation.

On the other hand, if N is sufficiently large, consecutive “buff[i]->intField” accesses will not share the same disk block or cache-line, so no spatial locality can be gained, and the “big_read” call would be considered candidate for transformation. If N (or locality in general) is unknown at compile time, feedback information received either from the programmer or from profiling memory-access traces can be used (in this case, value profiling of N may suffice).

The transformation is performed in one embodiment by replacing one or more data access calls that are deemed to have poor spatial locality by access calls to the individual fields as identified in the usage locations (P340). In addition, a copy of the original (full) access may be inserted at each escape point that was marked. Alternatively, a programmer can be consulted to help determine whether these accesses are needed at these escape points.

Considering the example in snippet 3 above, the big_read of snippet3 may be transformed into a fine_read call, as provided below:

```
    int foo( ){
        int ok = fine_read (file_location, &(buff->int_Field),
sizeof(intField),some_offset);
        if (ok)
          store_int(buff);
        return buff->intField;
    }
```

The “fine_read” conveys the amount of data that is needed, and indicates to underlying operating system layers that no spatial locality optimizations are needed, and that any additional data read from the disk may be dropped before transferring the desired data over the network. Having identified that a part of the data structure is needed, it is further possible to transmit the target data (e.g. across functions, as in the call to store_int in snippet 3) instead of the entire structure.

A similar implementation may be applicable to “write” operations that have poor spatial locality. In one embodiment, the analysis is initiated when a write access is detected, and works backwards to determine which of the fields being written were modified, or remained intact after being read from the same location. Similar escape situations may apply, and may be dealt with by duplicating paths to the write access.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

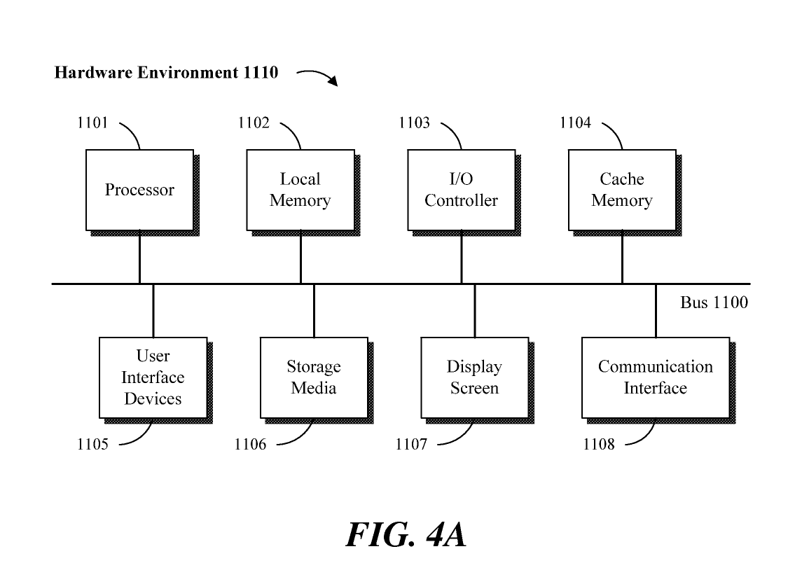

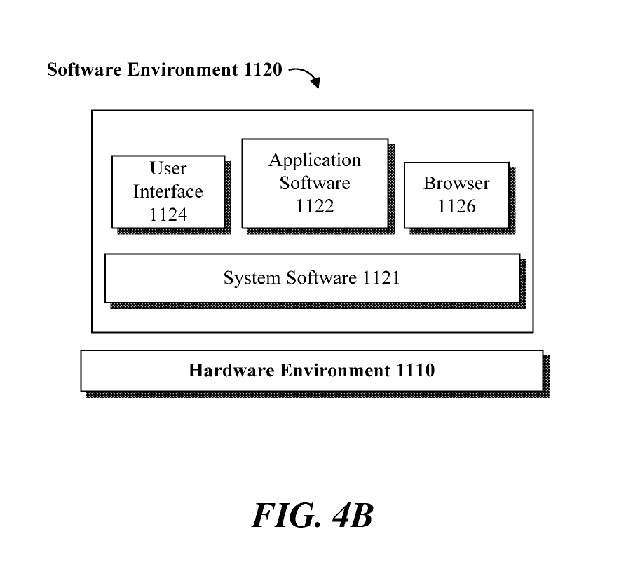

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of computer readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other computer-usable or computer readable media. Within the context of this disclosure, a computer usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a computer-usable or computer readable storage medium that provides program code for use by, or in connection with, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

Cloud computing is a model of service delivery for enabling convenient, on-demand network access to a shared pool of configurable computing resources (e.g. networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

Using the on-demand self-service, a cloud consumer may unilaterally provision computing capabilities, such as server time and network storage, as needed automatically without requiring human interaction with the service's provider. Broad network access capabilities may be available over a network and accessed through standard mechanisms that promote use by heterogeneous thin or thick client platforms (e.g., mobile phones, laptops, and PDAs).

Resource pooling allows the provider's computing resources that are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity capabilities may be rapidly and elastically provisioned, in some cases automatically, to quickly scale out and rapidly released to quickly scale in. To the consumer, the capabilities available for provisioning often appear to be unlimited and may be purchased in any quantity at any time. Measured service allows cloud systems automatically control and optimize resource use by leveraging a metering capability at some level of abstraction appropriate to the type of service (e.g., storage, processing, bandwidth, and active user accounts). Resource usage may be monitored, controlled, and reported providing transparency for both the provider and consumer of the utilized service.

Several service models are available, depending on implementation. Software as a Service (SaaS) provides the capability to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS) provides the capability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS) provides the capability to provision processing, storage, networks, and other fundamental computing resources where the consumer is able to deploy and run arbitrary software, which may include operating systems and applications. The consumer does not manage or control the underlying cloud infrastructure but has control over operating systems, storage, deployed applications, and possibly limited control of select networking components (e.g., host firewalls).

Several deployment models may be provided. A private cloud provides a cloud infrastructure that is operated solely for an organization. It may be managed by the organization or a third party and may exist on-premises or off-premises. A community cloud provides a cloud infrastructure that is shared by several organizations and supports a specific community that has shared concerns (e.g., mission, security requirements, policy, and compliance considerations). It may be managed by the organizations or a third party and may exist on-premises or off-premises.

A public cloud may provide a cloud infrastructure that is made available to the general public or a large industry group and is owned by an organization selling cloud services. A hybrid cloud provides a cloud infrastructure that is a composition of two or more clouds (private, community, or public) that remain unique entities but are bound together by standardized or proprietary technology that enables data and application portability (e.g., cloud bursting for load-balancing between clouds).

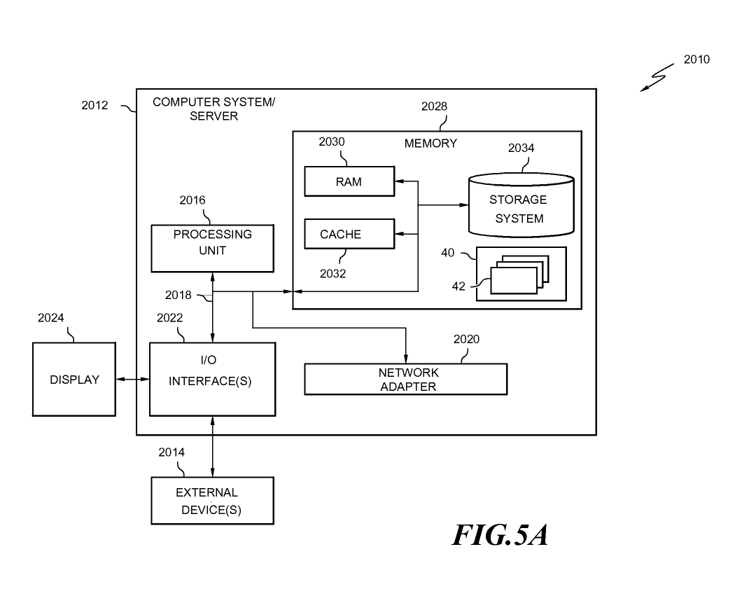

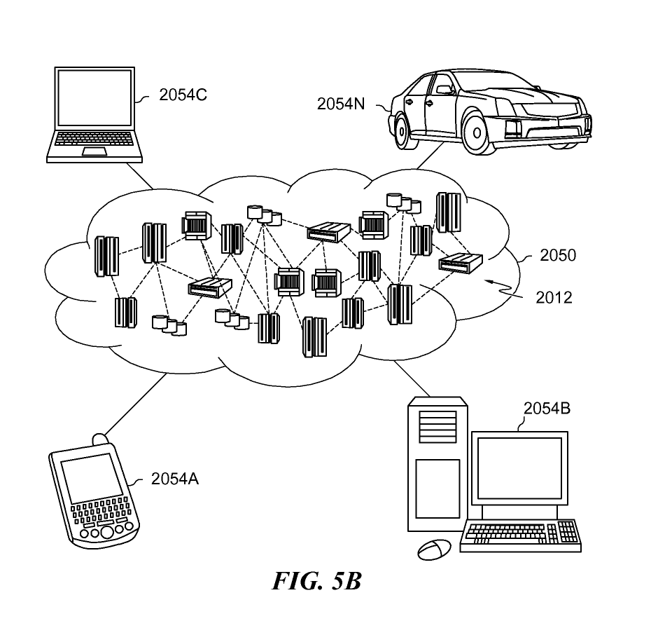

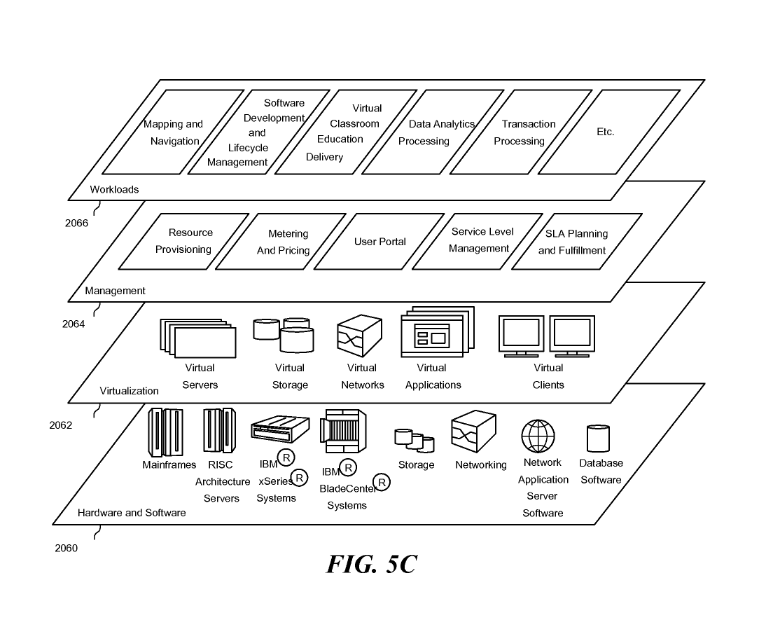

A cloud computing environment is service oriented with a focus on statelessness, low coupling, modularity, and semantic interoperability. At the heart of cloud computing is an infrastructure comprising a network of interconnected nodes. Referring now to FIG. 5A, a schematic of an example of a cloud computing node is shown. Cloud computing node 2010 is one example of a suitable cloud computing node and is not intended to suggest any limitation as to the scope of use or functionality of embodiments described herein. Regardless, cloud computing node 2010 is capable of being implemented and/or performing any of the functionality set forth hereinabove.

In cloud computing node 2010, there is a computer system/server 2012, which is operational with numerous other general purpose or special purpose computing system environments or configurations. Examples of well-known computing systems, environments, and/or configurations that may be suitable for use with computer system/server 2012 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 2012 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 2012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5A, computer system/server 2012 in cloud computing node 2010 is shown in the form of a general-purpose computing device. The components of computer system/server 2012 may include, but are not limited to, one or more processors or processing units 2016, a system memory 2028, and a bus 2018 that couples various system components including system memory 2028 to processor 2016.

Bus 2018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 2012 typically includes a variety of computer system readable media. Such media may be any available media that is accessible by computer system/server 2012, and it includes both volatile and non-volatile media, removable and non-removable media. System memory 2028 may include computer system readable media in the form of volatile memory, such as random access memory (RAM) 30 and/or cache memory 32.

Computer system/server 2012 may further include other removable/non-removable, volatile/non-volatile computer system storage media. By way of example, storage system 34 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided.

In some instances, the above components may be connected to bus 2018 by one or more data media interfaces. As will be further depicted and described below, memory 2028 may include at least one program product having a set (e.g., at least one) of program modules that are configured to carry out the functions of one or more embodiments.

Program/utility 2040, having a set (at least one) of program modules 42, may be stored in memory 2028 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of one or more embodiments.

Computer system/server 2012 may also communicate with one or more external devices 2014 such as a keyboard, a pointing device, a display 2024, etc.; one or more devices that enable a user to interact with computer system/server 2012; and/or any devices (e.g., network card, modem, etc.) that enable computer system/server 2012 to communicate with one or more other computing devices. Such communication may occur via I/O interfaces 2022. Still yet, computer system/server 2012 may communicate with one or more networks such as a local area network (LAN), a general wide area network (WAN), and/or a public network (e.g., the Internet) via network adapter 2020.

As depicted, network adapter 2020 communicates with the other components of computer system/server 2012 via bus 2018. It should be understood that although not shown, other hardware and/or software components could be used in conjunction with computer system/server 2012. Examples, include, but are not limited to: microcode, device drivers, redundant processing units, external disk drive arrays, RAID systems, tape drives, and data archival storage systems, etc.

Referring now to FIG. 5B, illustrative cloud computing environment 2050 is depicted. As shown, cloud computing environment 2050 comprises one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate.

Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device.

It is understood that the types of computing devices 54A-N shown in FIG. 5B are intended to be illustrative only and that computing nodes 2010 and cloud computing environment 2050 may communicate with any type of computerized device over any type of network and/or network addressable connection (e.g., using a web browser).

Referring now to FIG. 5C, a set of functional abstraction layers provided by cloud computing environment 2050 (FIG. 5B) is shown. It should be understood in advance that the components, layers, and functions shown in FIG. 5C are intended to be illustrative of one or more embodiments and are not limited thereto. As depicted, the following layers and corresponding functions are provided.

Hardware and software layer 2060 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 2062 provides an abstraction layer from which the following examples of virtual entities may be provided: virtual servers; virtual storage; virtual networks, including virtual private networks; virtual applications and operating systems; and virtual clients. In one example, management layer 2064 may provide the functions described below. Resource provisioning provides dynamic procurement of computing resources and other resources that are utilized to perform tasks within the cloud computing environment.

Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met.

Service Level Agreement (SLA) planning and fulfillment provide pre-arrangement for, and procurement of, cloud computing resources for which a future requirement is anticipated in accordance with an SLA. Workloads layer 2066 provides examples of functionality for which the cloud computing environment may be utilized. Examples of workloads and functions which may be provided from this layer include: mapping and navigation; software development and lifecycle management; virtual classroom education delivery; data analytics processing; transaction processing; etc.

What is claimed is:

1. A data transmission optimization method comprising:
analyzing program code to identify data access calls in the program code, using one or more processor;
determining whether a first data access call is for retrieving target data stored in a data structure with a plurality of fields, wherein the target data is stored in one or more target fields of the data structure;
determining whether servicing the first data access call will result in transfer of non-target data stored in one or more non-target fields in the data structure; and
replacing the first data access call with a second data access call, wherein servicing the second data access call will result in transfer of the target data and minimizes the transfer of non-target data.

2. The method of claim 1, wherein the analyzing is performed during compilation of the program code.

3. The method of claim 1, wherein the data access call is for reading the target data.

4. The method of claim 3, wherein the target data is stored on at least a first storage medium that is remotely connected to a computing system that makes the access call for retrieving the target data, wherein the retrieved target data is stored in at least a second storage medium locally connected to said computing system.

5. The method of claim 4, wherein the computing system that makes the access call is a client computer communicating with a server computer located in a remote network to which the first storage medium is coupled.

6. The method of claim 1, wherein replacing the first data access call with the second data access call takes place in consideration with spatial locality of the target fields.

7. The method of claim 1, wherein replacing the first data access call with the second data access call takes place in consideration with need for values in the data structure other than the values in the target fields.

8. The method of claim 1, wherein replacing the first data access call with the second data access call takes place in consideration with size of a cache line in relationship to size of the entire data structure, wherein the cache line is used to stored the retrieved target and non-target data.

9. The method of claim 1, wherein the program code is analyzed based on a forward data flow analysis of the program code.

10. The method of claim 1, wherein the program code is analyzed based on data profiling or memory trace analysis of data retrieved during test runs of the program code.

11. A data transmission optimization system comprising:
one or more processors and memory for storing program code;
a logic unit for analyzing the program code to identify data access calls in the program code;
a logic unit for determining whether a first data access call is for retrieving target data stored in a data structure with a plurality of fields, wherein the target data is stored in one or more target fields of the data structure;
a logic unit for determining whether servicing the first data access call will result in transfer of non-target data stored in one or more non-target fields in the data structure; and
a logic unit for replacing the first data access call with a second data access call, wherein servicing the second data access call will result in transfer of the target data and minimizes the transfer of non-target data.

12. The system of claim 11, wherein the analyzing is performed during compilation of the program code.

13. The system of claim 11, wherein the data access call is for reading the target data.

14. The system of claim 13, wherein the target data is stored on at least a first storage medium that is remotely connected to a computing system that makes the access call for retrieving the target data, wherein the retrieved target data is stored in at least a second storage medium locally connected to said computing system.

15. The system of claim 14, wherein the computing system that makes the access call is a client computer communicating with a server computer located in a remote network to which the first storage medium is coupled.

16. The system of claim 11, wherein replacing the first data access call with the second data access call takes place in consideration with spatial locality of the target fields.

17. The system of claim 11, wherein replacing the first data access call with the second data access call takes place in consideration with need for values in the data structure other than the values in the target fields.

18. The system of claim 11, wherein replacing the first data access call with the second data access call takes place in consideration with size of a cache line in relationship to size of the entire data structure, wherein the cache line is used to stored the retrieved target and non-target data.

19. A computer program product comprising a non-transitory computer readable storage medium having a computer readable program, wherein the computer readable program when executed on a computer causes the computer to:
analyze program code to identify data access calls in the program code;
determine whether a first data access call is for retrieving target data stored in a data structure with a plurality of fields, wherein the target data is stored in one or more target fields of the data structure;
determine whether servicing the first data access call will result in transfer of non-target data stored in one or more non-target fields in the data structure; and
replace the first data access call with a second data access call, wherein servicing the second data access call will result in transfer of the target data and minimizes the transfer of non-target data.

20. The computer program product of claim 21, wherein the analyzing is performed during compilation of the program code.
